(19) United States
(12) Patent Application Publication
(10) Pub. No.: US 2024/0261684 A1
(43) Pub. Date: Aug. 8, 2024

(54) INTERACTION METHOD AND APPARATUS IN VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company, Shenzhen (CN)

(72) Inventor: Fenlin CAI, Shenzhen (CN)

(21) Appl. No.: 18/638,550

(22) Filed: Apr. 17, 2024

Related U.S. Application Data
(63) Continuation of application No. PCT/CN23/92695, filed on May 8, 2023.

(30) Foreign Application Priority Data
Jul. 25, 2022 (CN) 202210876584.3

(51) Int. Cl. A63F 13/5378; A63F 13/58; A63F 13/69

(52) U.S. Cl. CPC A63F 13/5378; A63F 13/58; A63F 13/69

(57) ABSTRACT

This application provides an interaction method of controlling a virtual object in a virtual scene performed by an electronic device. The method includes: displaying a virtual object and a virtual natural element representing a virtual natural phenomenon in a virtual scene, wherein the virtual natural element is stationary in the virtual scene; transforming the virtual natural element into an interactive target object when the virtual object is within a negative impact region of the virtual natural element; and controlling the virtual object to interact with the target object in the virtual scene when an interaction instruction for the target object is received.

### CROSS-REFERENCE TO RELATED APPLICATIONS

This application is a continuation application of PCT Patent Application No. PCT/CN2023/092695, entitled “INTERACTION METHOD AND APPARATUS IN VIRTUAL SCENE, ELECTRONIC DEVICE, COMPUTER-READABLE STORAGE MEDIUM, AND COMPUTER PROGRAM PRODUCT” filed on May 8, 2023, which claims priority to Chinese Patent Application No. 202210876584.3, entitled “INTERACTION METHOD AND APPARATUS IN VIRTUAL SCENE, ELECTRONIC DEVICE, COMPUTER-READABLE STORAGE MEDIUM, AND COMPUTER PROGRAM PRODUCT” filed on Jul. 25, 2022, all of which are incorporated herein by reference in its entirety.

### FIELD OF THE TECHNOLOGY

This application relates to the field of virtualization and human-computer interaction technologies, and in particular, to an interaction method and apparatus in a virtual scene, an electronic device, a computer-readable storage medium, and a computer program product.

### BACKGROUND OF THE DISCLOSURE

In most three-dimensional (3D) open world games in the related art, a player may be completely free to explore on a map. During the free exploration, the player needs to actively search for a task object or a monster to interact with. However, due to lack of guidance, an excessively single interactive object, or the like, the player may feel confused and lack a game goal in actual experience, causing loss of players. In addition, since most of the time is spent on searching for the task object or the monster, the player cannot fully interact with the task object or the monster in a game, resulting in excessively low efficiency of human-computer interaction and a waste of hardware processing resources.

### SUMMARY

Embodiments of this application provide an interaction method and apparatus in a virtual scene, an electronic device, a computer-readable storage medium, and a computer program product, which can improve efficiency of human-computer interaction and a utilization rate of hardware processing resources.

Technical solutions in the embodiments of this application are implemented as follows:

An embodiment of this application provides an interaction method of controlling a virtual object in a virtual scene. The method is performed by an electronic device, and includes:
displaying a virtual object and a virtual natural element representing a virtual natural phenomenon in a virtual scene, wherein the virtual natural element is stationary in the virtual scene;
transforming the virtual natural element into an interactive target object when the virtual object is within a negative impact region of the virtual natural element; and
controlling the virtual object to interact with the target object in the virtual scene when an interaction instruction for the target object is received.

An embodiment of this application provides an electronic device, including:
a memory, configured to store a computer-executable instruction; and
a processor, configured to implement the interaction method of controlling a virtual object in a virtual scene provided in the embodiments of this application when executing the computer-executable instruction stored in the memory.

An embodiment of this application provides a non-transitory computer-readable storage medium, having a computer-executable instruction stored therein, the computer-executable instruction, when executed by a processor of an electronic device, causing the electronic device to implement the interaction method of controlling a virtual object in a virtual scene provided in the embodiments of this application.

The embodiments of this application have the following beneficial effects:

In the foregoing embodiments of this application, the virtual object and the virtual natural element that causes the negative impact to the virtual environment in the virtual scene exist in the virtual scene. When the virtual object enters the negative impact region of the virtual natural element, the virtual natural element is transformed into the target object for the virtual object to interact with, so that the virtual object interacts with the target object. In this way, when the virtual object is close to the virtual natural element, the virtual natural element is transformed into the interactive object to implement the interactive process, which enriches interactive objects during free exploration, reduces an exploration time, i.e., reduces a time for performing a human-computer interaction operation to implement the interactive process, thereby improving the efficiency of the human-computer interaction and a utilization rate of hardware resources of the electronic device.

### BRIEF DESCRIPTION OF THE DRAWINGS

FIG. 1 is a schematic diagram of an architecture of an interactive system in a virtual scene according to an embodiment of this application.

FIG. 2 is a schematic structural diagram of an electronic device according to an embodiment of this application.

FIG. 3 is a schematic flowchart of an interaction method in a virtual scene according to an embodiment of this application.

FIG. 4 is a schematic diagram of a relative positional relationship between a virtual object and a virtual natural element according to an embodiment of this application.

FIG. 5 is a schematic diagram of a relative positional relationship between a virtual object and a virtual natural element according to an embodiment of this application.

FIG. 6 is a schematic diagram showing that a virtual object travels toward a target virtual natural element according to an embodiment of this application.

FIG. 7 is a schematic diagram of a negative impact caused by a virtual natural element to a virtual object according to an embodiment of this application.

FIG. 8 is a schematic diagram of superimposition of negative impact regions of virtual natural elements according to an embodiment of this application.

FIG. 9 is a schematic diagram of a relationship between a second negative impact value and a duration according to an embodiment of this application.

FIG. 10 is a schematic diagram of upgrade prompt information of a global impact source according to an embodiment of this application.

FIG. 11 is a schematic diagram of a virtual natural element according to an embodiment of this application.

FIG. 12 is a schematic diagram of a target object according to an embodiment of this application.

FIG. 13 is a schematic diagram of a first object according to an embodiment of this application.

FIG. 14 is a schematic diagram of a process of transforming a target object into a virtual natural element according to an embodiment of this application.

FIG. 15 is a schematic diagram of upgrade prompt information of a virtual natural element according to an embodiment of this application.

FIG. 16 is a flowchart of a transformation logic between a pollution source and a key monster according to an embodiment of this application.

### DESCRIPTION OF EMBODIMENTS

To make the objectives, technical solutions, and advantages of this application clearer, embodiments of this application are described in detail with reference to the accompany drawings. The described embodiments are not to be construed as a limitation on the embodiments of this application. All other embodiments obtained by a person of ordinary skill in the art without creative efforts fall within the protection scope of this application.

In the following description, a term “some embodiments” involved describes subsets of all possible embodiments, but “some embodiments” may be the same subset or different subsets of all of the possible embodiments, and may be combined with each other without conflict.

In the following description, a term “first/second/third” involved is merely used for distinguishing between similar objects and does not represent a specific order of objects. “First/second/third” may be transposed for a specific order or a sequence when allowed, so that the embodiments of this application described herein can be implemented in an order other than those illustrated or described herein.

Unless otherwise defined, meanings of all technical and scientific terms used in this specification are the same as those usually understood by a person skilled in the art to which this application belongs. The terms used in this specification are merely intended to describe objectives of the embodiments of this application, but are not intended to limit this application.

Before the embodiments of this application are further described in detail, terms involved in the embodiments of this application are described. The terms involved in the embodiments of this application are applicable to the following explanations.
1) Shooting game: It includes all games in which firearms are configured for long-range attack, including but not limited to first-person shooting games and third-person shooting games.
2) Third-person perspective: It is a perspective from which a player and all battle elements within a specific surrounding environment may be seen in a picture when an in-game camera is at a specific distance behind a player character.
3) Open world: It refers to a virtual game scene in which battle scenes in a game are completely free and open. In the open world, a player may freely move forward and explore in any direction, and a very large distance is defined between boundaries in various directions.
4) In response to: It is used for indicating a condition or a status on which a performed operation depends. When the condition or the status is satisfied, one or more operations may be performed in real time or with a set delay. Unless otherwise specified, an order in which a plurality of operations are performed is not limited.
5) Virtual scene: It is a virtual scene displayed (or provided) when an application runs on a terminal. The virtual scene may be a simulation environment for the real world, or may be a semi-simulation and semi-fiction virtual environment, and may further be a purely fictional virtual environment. The virtual scene may be any one of a two-dimensional virtual scene, a 2.5-dimensional virtual scene, or a three-dimensional virtual scene.

For example, the virtual scene may include sky, land, ocean, and the like. The land may include environmental elements such as desert and city, and a user may control a virtual object to perform an activity in the virtual scene. The activity includes, but is not limited to at least one of adjusting a body posture, crawling, walking, running, riding, jumping, driving, pickup, shooting, attacking, and throwing. The virtual scene may be displayed from a first-person perspective (for example, a user plays a role of a virtual object in a game from the perspective of the user); or the virtual scene may be displayed from a third-person perspective (for example, a game is played with the user chasing the virtual object in the game); and the virtual scene may further be displayed from a bird's-eye view. The foregoing perspectives may be switched randomly.
6) Virtual object: The virtual objects are images of various people and things that may interact in a virtual scene, or movable objects in the virtual scene. The movable objects may be a virtual person, a virtual animal, a cartoon character, and the like, for example, characters, animals, plants, oil drums, walls, or stones displayed in the virtual scene. The virtual object may be a virtual image for representing a user in the virtual scene. The virtual scene may include a plurality of virtual objects, and each virtual object has a shape and a volume in the virtual scene, and occupies some space in the virtual scene.

For example, the virtual object may be a user character controlled through an operation on a client, or may be an artificial intelligence (AI) character set in a virtual scene fight through training, and may further be a non-player character (NPC) set in virtual scene interaction. A quantity of virtual objects participating in interaction in the virtual scene may be preset, or may be dynamically determined based on a quantity of clients participating in the interaction.

In an open-world shooting game in the related art, it is required that players be allowed to explore freely, so no linear or strong prompts are provided in general to guide a player to a target. To be specific, generally, when the player approaches a battle target or finds a key NPC to receive a task, a specific prompt or guidance is provided for a high-speed player to be upgraded in a direction. Actual experience is mostly to find several designated monsters to kill or hit items, have a dialogue with an NPC, and the like. The game experience is relatively monotonous, and specific packaging and creation of an atmosphere of a sense of open world substitution are lacked. This may cause the player to feel that the target is missing in a big map, and then the player may be lost. In addition, due to lack of sufficient filling content, when the player quickly finds and kills a game target, a game duration also ends prematurely, which may cause the game content to be consumed faster than expected, further resulting in the loss of players.

Based on this, embodiments of this application provide an interaction method and apparatus in a virtual scene, an electronic device, a non-transitory computer-readable storage medium, and a computer program product. Several player-selectable virtual natural elements are created on a map. When a player feels confused about a target, the player is guided to challenge the nearest virtual natural element in a big map. The virtual natural element is transformed into a monster to fight against the player when the player approaches, and the player may obtain generous rewards as long as the player succeed in the challenge. This not only enriches game experience, but also avoids the loss of players.

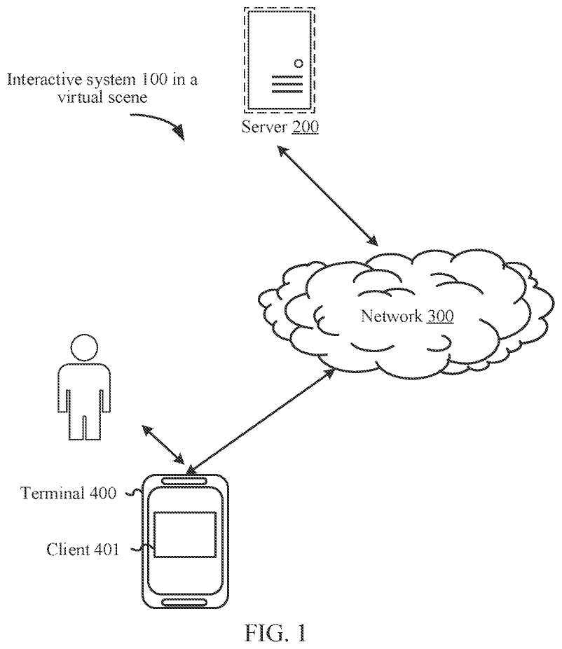

FIG. 1 is a schematic diagram of an architecture of an interactive system 100 in a virtual scene according to an embodiment of this application. To implement an interactive application scenario in a virtual scene (for example, the interactive application scenario in the virtual scene may be an application scenario for interaction based on a virtual scene in a game application (APP). For example, when a player is playing the game APP, a virtual natural element such as a tornado is displayed in the virtual scene, and when the player approaches the tornado, the tornado is transformed into an interactive monster, so that the player can kill the monster by using a throwing prop or a skill), an interactive client 401 (i.e., a game APP) in the virtual scene is arranged on a terminal (a terminal 400 is exemplarily shown). The terminal 400 is connected to a server 200 through a network 300. The network 300 may be a wide area network, a local area network, or a combination thereof. Data transmission is implemented by using a wireless or wired link.

The terminal 400 is configured to transmit, in response to a triggering operation on a virtual scene including a virtual object and a virtual natural element belonging to a virtual natural phenomenon, a display request of the virtual scene to the server 200.

The server 200 is configured to transmit, to the terminal 400 based on the received display request of the virtual scene, the virtual scene including the virtual object and the virtual natural element belonging to the virtual natural phenomenon.

The terminal 400 is further configured to: receive the virtual scene including the virtual object and the virtual natural element belonging to the virtual natural phenomenon; present the virtual scene, and display the virtual object and the virtual natural element belonging to the virtual natural phenomenon in the virtual scene, the virtual natural element being configured to cause a negative impact to an environment in which the virtual natural element is located; control the virtual natural element to be transformed into an interactive target object when the virtual object is within a sensing region of the virtual natural element, a negative impact region of the virtual natural element including the sensing region; and control the virtual object to interact with the target object in the virtual scene when an interaction instruction for the target object is received.

In some embodiments, the server 200 may be an independent physical server, or may be a server cluster formed by a plurality of physical servers or a distributed system, and may further be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a set-top box, an intelligent voice interactive device, a smart home appliance, a virtual reality device, an on-board terminal, an aircraft, a mobile device (for example, a mobile phone, a portable music player, a personal digital assistant, a dedicated messaging device, a portable game device, a smart speaker, and a smartwatch), or the like, but is not limited thereto. The terminal and the server may be directly or indirectly connected through wired or wireless communication, which is not limited in the embodiments of this application.

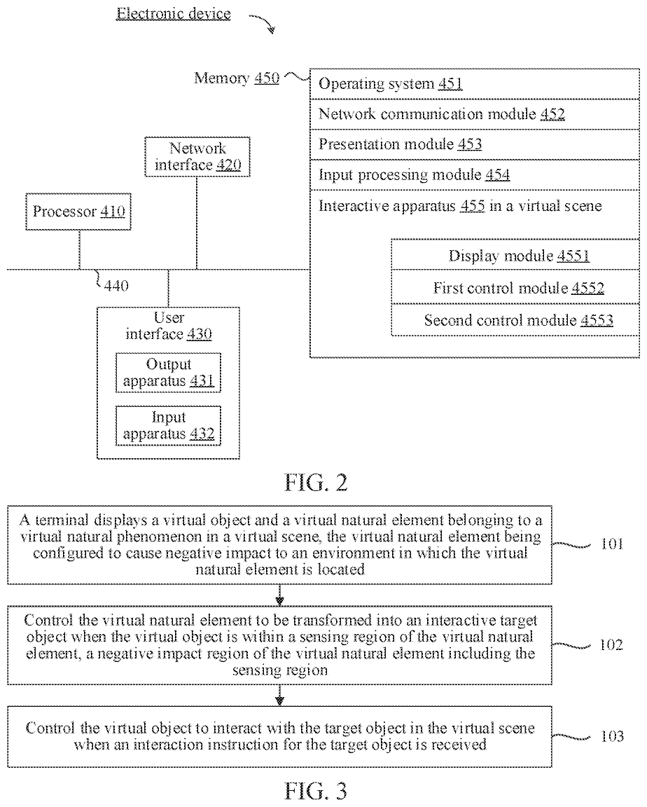

Next, an electronic device implementing the interaction method in a virtual scene provided in the embodiments of this application is described. FIG. 2 is a schematic structural diagram of an electronic device according to an embodiment of this application. An example in which the electronic device is the terminal shown in FIG. 1 is used. The electronic device shown in FIG. 2 includes at least one processor 410, a memory 450, at least one network interface 420, and a user interface 430. Various components in the terminal 400 are coupled together through a bus system 440. The bus system 440 is configured to implement connection and communication between the components. In addition to a data bus, the bus system 440 further includes a power bus, a control bus, and a status signal bus. However, for the sake of clarity, all buses are marked as the bus system 440 in FIG. 2.

The processor 410 may be an integrated circuit chip with a signal processing capability, for example, a general-purpose processor, a digital signal processor (DSP), another programmable logic device, a discrete gate or a transistor logic device, a discrete hardware component, or the like. The general-purpose processor may be a microprocessor, any conventional processor, or the like.

The user interface 430 includes one or more output apparatuses 431 that enable display of media content, including one or more speakers and/or one or more visual display screens. The user interface 430 further includes one or more input apparatuses 432, including user interface components that facilitate user input, such as a keyboard, a mouse, a microphone, a touch screen display, a camera, and another input button and control.

The memory 450 is removable, non-removable, or a combination thereof. An exemplary hardware device includes a solid-state memory, a hard disk driver, an optical disk driver, and the like. In some embodiments, the memory 450 includes one or more storage devices that are physically located away from the processor 410.

The memory 450 includes a volatile memory or a non-volatile memory, or may include both the volatile memory and the non-volatile memory. The non-volatile memory may be a read-only memory (ROM). The volatile memory may be a random access memory (RAM). The memory 450 described in this embodiment of this application is intended to include any suitable type of memory.

In some embodiments, the memory 450 can store data to support various operations. Examples of the data include a program, a module, and a data structure or a subset or a superset thereof Δn exemplary description is provided below.

An operating system 451 includes system programs configured to process various basic system services and perform hardware-related tasks, for example, a framework layer, a core library layer, and a driver layer, which are configured to implement various basic services and process hardware-based tasks.

A network communication module 452 is configured to reach another electronic device includes device through one or more (wired or wireless) network interfaces 420. An exemplary network interface 420 includes a Bluetooth interface, a wireless compatibility authentication (WiFi) interface, a universal serial bus (USB) interface, and the like.

A presentation module 453 is configured to enable display of information through the one or more output apparatuses 431 (for example, a display screen and a speaker) associated with the user interface 430 (for example, a user interface configured to operate a peripheral device and display content and information).

An input processing module 454 is configured to detect user inputs or interactions from the one or more input apparatuses 432 and translate the detected inputs or interactions.

In some embodiments, an apparatus provided in this embodiment of this application may be implemented by software. FIG. 2 shows an interactive apparatus 455 in a virtual scene stored in the memory 450, which may be software in the form of programs and plug-ins, including the following software modules: a display module 4551, a first control module 4552, and a second control module 4553. The modules are logical, and therefore may be arbitrarily combined or further split based on implemented functions. Functions of the modules are described below.

In some other embodiments, the apparatus provided in the embodiments of this application may be implemented by hardware. In an example, the interactive apparatus in a virtual scene provided in the embodiments of this application may be a processor in the form of a hardware decoding processor, which is programmed to perform the interaction method in a virtual scene provided in the embodiments of this application. For example, the processor in the form of the hardware decoding processor may be one or more application specific integrated circuits (ASICs), a DSP, a programmable logic device (PLD), a complex programmable logic device (CPLD), a field-programmable gate array (FPGA), or another electronic element.

In some embodiments, the terminal or a server may implement the interaction method in a virtual scene provided in the embodiments of this application by running a computer program. For example, the computer program may be a native program or a software module in an operating system, or may be a native application (APP), i.e., a program that needs to be installed in the operating system to run, such as an instant messaging APP or a web browser APP, or may be an applet, i.e., a program that only needs to be downloaded into a browser environment to run; and may further be an applet that can be embedded in any APP. In a word, the foregoing computer program may be an APP, a module, or a plug-in of any form.

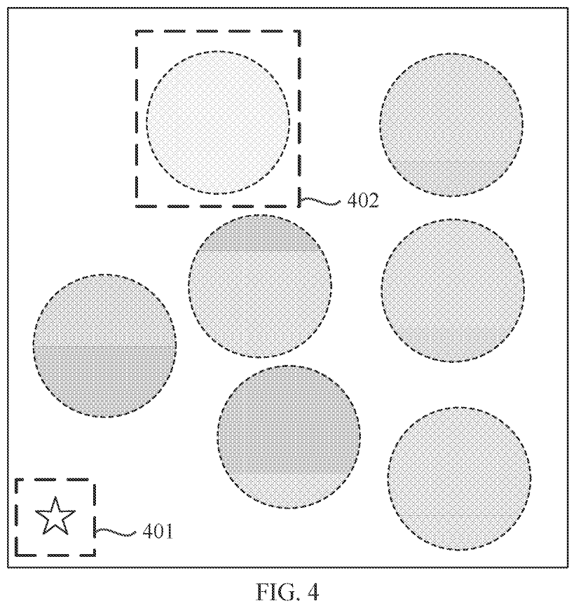

Based on the foregoing description of the interactive system in a virtual scene and the electronic device provided in the embodiments of this application, the interaction method in a virtual scene provided in the embodiments of this application is described below. During an actual implementation, the interaction method in a virtual scene provided in the embodiments of this application may be implemented by a terminal or a server alone, or may be implemented by the terminal and the server collaboratively. A description is given by using an example in which the terminal 400 in FIG. 1 alone performs the interaction method in a virtual scene provided in the embodiments of this application. FIG. 3 is a schematic flowchart of an interaction method in a virtual scene according to an embodiment of this application. A description is given with reference to operations shown in FIG. 3.

Operation 101: A terminal displays a virtual object and a virtual natural element belonging to a virtual natural phenomenon in a virtual scene, the virtual natural element being configured to cause a negative impact to an environment in which the virtual natural element is located.

During an actual implementation, an APP supporting the virtual scene is installed on the terminal. The APP may be any one of a first-person shooting game, a third-person shooting game, a multiplayer online battle arena, a virtual reality APP, a three-dimensional map program, and a multiplayer gunfight survival game. A user may use the terminal to operate the virtual object located in the virtual scene to perform an activity.

When the user opens an APP on the terminal and the terminal runs the APP, the terminal presents a picture of the virtual scene. Herein, the picture of the virtual scene is obtained by observing the virtual scene from a first-person perspective, or obtained by observing the virtual scene from a third-person perspective. The picture of the virtual scene includes the virtual object and the virtual natural element belonging to the virtual natural phenomenon. The virtual object may be a player character controlled by a current player, or may be a player character controlled by another player (a teammate) belonging to the same group as the current player. The virtual natural phenomenon to which the virtual natural element belongs may be a natural phenomenon such as a tornado or a volcano that causes a negative impact to the environment in which the virtual natural element is located. However, a region in which the virtual natural element causes the negative impact to the environment in which the virtual natural element is located is a negative impact region.

In an example, when the virtual natural phenomenon is a virtual tornado, a virtual natural element belonging to the virtual tornado is displayed in a virtual scene. The negative impact region of the virtual natural element is a region affected by the virtual tornado, and a light intensity within the negative impact region of the virtual natural element is lower than that within a non-negative impact region in the virtual scene and is destructive to the virtual object in the negative impact region.

In an example, when the virtual natural phenomenon is a virtual volcano, a virtual natural element belonging to the virtual volcano is displayed in a virtual scene. The negative impact region of the virtual natural element is a region affected by the virtual volcano, and a degree of ground fracturing and an environment temperature in the negative impact region of the virtual natural element are higher than that in a non-negative impact region of the virtual scene and are destructive to the virtual object in the negative impact region.

Within the negative impact region of the virtual natural element, a smaller distance to the virtual natural element indicates a stronger negative impact to a corresponding environment by the virtual natural element.

During an actual implementation, when a plurality of virtual natural elements exist, the plurality of virtual natural elements belong to at least two virtual natural phenomena such as a volcano and a tornado. In the virtual scene, a process of displaying the virtual natural element belonging to the virtual natural phenomenon includes displaying the plurality of virtual natural elements belonging to the at least two virtual natural phenomena in the virtual scene. The virtual natural elements of different virtual natural phenomena cause different negative impacts to environments in which the virtual natural elements are located. For example, a tornado is configured to reduce a light intensity of an environment in which a virtual natural element is located and destroy a virtual object in the environment in which the virtual natural element is located. The volcano is configured to dry and crack a ground of the environment in which the virtual natural element is located, raising a temperature of the environment in which the virtual natural element is located, and destroy the virtual object in the environment in which the virtual natural element is located.

Through application of the foregoing embodiments, when a plurality of virtual natural elements exist, the plurality of virtual natural elements belong to at least two virtual natural phenomena, and the plurality of virtual natural elements belonging to the at least two virtual natural phenomena are displayed in the virtual scene. In this way, diversity of interactive processes in the virtual scene is increased, and a sense of immersion and interactive experience of the user are improved, thereby improving efficiency of human-computer interaction and a utilization rate of hardware resources of an electronic device.

In some embodiments, in addition to displaying the virtual object and the virtual natural element belonging to the virtual natural phenomenon, a map of the virtual scene is also displayed in the virtual scene, and a relative positional relationship between the virtual object and the virtual natural element is dynamically displayed on the map. Exemplarily, FIG. 4 is a schematic diagram of a relative positional relationship between a virtual object and a virtual natural element according to an embodiment of this application. Based on FIG. 4, in a dashed box 401 is the virtual object, and a shadow circle in a dashed box 402 is the virtual natural element. As the virtual object moves, the relative positional relationship between the virtual object and the virtual natural element is dynamically displayed on a map.

During an actual implementation, during display of the virtual object and the virtual natural element belonging to a virtual natural phenomenon, the map of a virtual scene is displayed to dynamically display the relative positional relationship between the virtual object and the virtual natural element on the map. In this way, a user is more aware of a distance between the user and the virtual natural element, which is convenient for the user to find the corresponding virtual natural element, thereby improving user experience and reducing a time for the user to search for the virtual natural element.

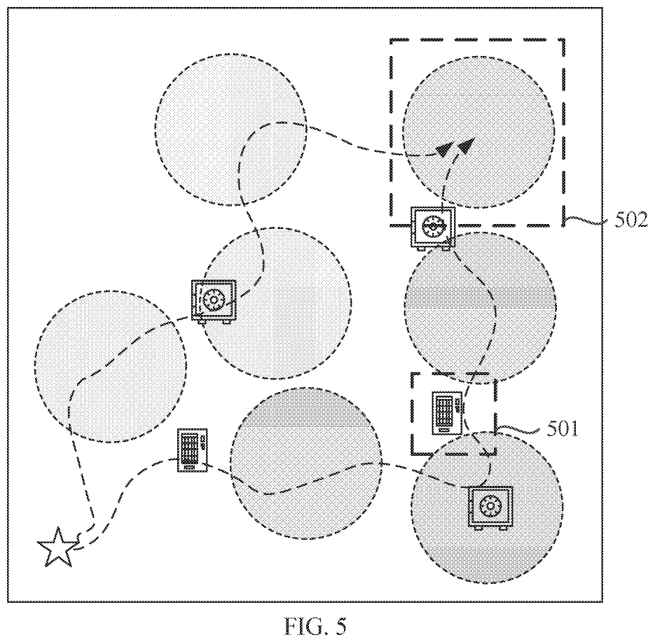

During an actual implementation, a manner of dynamically displaying the relative positional relationship between the virtual object and the virtual natural element on the map may further be dynamically displaying a traveling path between the virtual object and the virtual natural element on the map, identifying the virtual object at one end of the traveling path, and identifying the virtual natural element at an other end of the traveling path. The traveling path is configured to guide the virtual object to move into a sensing region of the virtual natural element along the traveling path. Exemplarily, FIG. 5 is a schematic diagram of a relative positional relationship between a virtual object and a virtual natural element according to an embodiment of this application. Based on FIG. 5, a traveling path between the virtual object and the virtual natural element in a dashed box 502 is displayed. Herein, in a dashed box 501 is a supply position set in a virtual scene, such as a virtual store. The supply position herein is configured to increase a state value of the virtual object such as a health point and a traveling speed. Herein, the traveling path may be a path including the supply position, or may be a path with the shortest distance. In this way, different paths are presented for the virtual object to select from, so that the virtual object determines, based on a state thereof, whether a supply is needed, or directly selects the path with the shortest distance, to improve traveling efficiency and avoid wasting a travel time.

The virtual object may directly travel toward the virtual natural element based on the traveling path on a map or by highlighting a path under a foot of the virtual object or under a vehicle in the virtual scene, for the virtual object to travel toward the virtual natural element.

Through application of the foregoing embodiment, the traveling path between the virtual object and the virtual natural element is dynamically displayed on the map, so that a user is more aware of a relative position between the user and the virtual natural element, which is convenient for the user to find the corresponding virtual natural element, thereby improving user experience, reducing the time for the user to search for the virtual natural element, and improving efficiency of human-computer interaction and a utilization rate of hardware processing resources.

During an actual implementation, when a plurality of virtual natural elements exist, a target virtual natural element needs to be determined from the plurality of virtual natural elements. Herein, the target virtual natural element may be directly determined by a terminal, or may be determined by the user. Next, a process of determining the target virtual natural element is described by using the following two examples. A manner of determining the target virtual natural element includes but is not limited to the following two manners, which is not limited in the embodiments of this application.

In some embodiments, when a plurality of virtual natural elements exist, a distance between the virtual object and each of the virtual natural elements in the virtual scene is obtained. The virtual natural element with the shortest distance from the virtual object is selected as the target virtual natural element, to dynamically display the relative positional relationship between the virtual object and the target virtual natural element on the map.

In a practical application, when a plurality of virtual natural elements exist, only the relative positional relationship between the virtual object and the virtual natural element closest to the virtual object is displayed, which is convenient for the user to find the virtual natural element closest to the user, and reduces the time for the user to search for the virtual natural element.

In some other embodiments, when a plurality of virtual natural elements exist, options respectively corresponding to the virtual natural elements are presented. In response to a selection operation on a target option corresponding to the target virtual natural element, the virtual natural element corresponding to the target option is used as the target virtual natural element, thereby dynamically displaying the relative positional relationship between the virtual object and the target virtual natural element on the map.

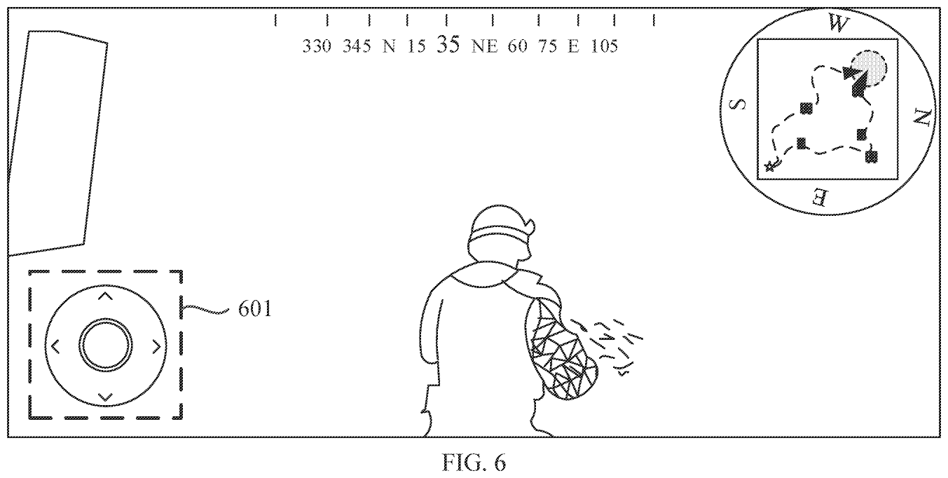

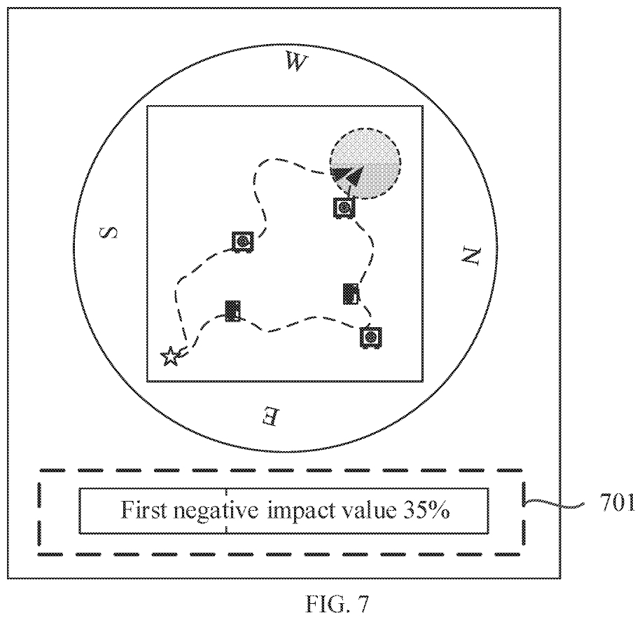

After the target virtual natural element is determined, a traveling path between the virtual object and the target virtual natural element is presented, and a direction movement control corresponding to the virtual object is displayed. The direction movement control may be a joystick control, and then in response to a movement control instruction received based on the direction movement control, the virtual object is controlled to move toward the target virtual natural element based on a direction (including forward, backward, left, and right) indicated by the movement control instruction. Exemplarily, FIG. 6 is a schematic diagram showing that a virtual object travels toward a target virtual natural element according to an embodiment of this application. Based on FIG. 6, a direction movement control is displayed in a dashed box 601. When a movement control instruction (such as a left movement control instruction) for the virtual object is received based on the direction movement control, the virtual object is controlled to move leftward in response to the movement control instruction.

During an actual implementation, in addition to a negative impact to an environment in which the virtual natural element is located, the virtual natural element further causes a negative impact to the virtual object. When the virtual object is within a negative impact region of the virtual natural element, a first negative impact value caused by the virtual natural element to the virtual object is displayed. The first negative impact value is configured for indicating a degree of obstruction (i.e., a magnitude of the obstruction) caused by the virtual natural element to movement of the virtual object within the negative impact region. The first negative impact value caused to the virtual object herein is configured for indicating a negative impact caused to a state value of the virtual object, for example, reduce a traveling speed of the virtual object, or reduce a health point of the virtual object.

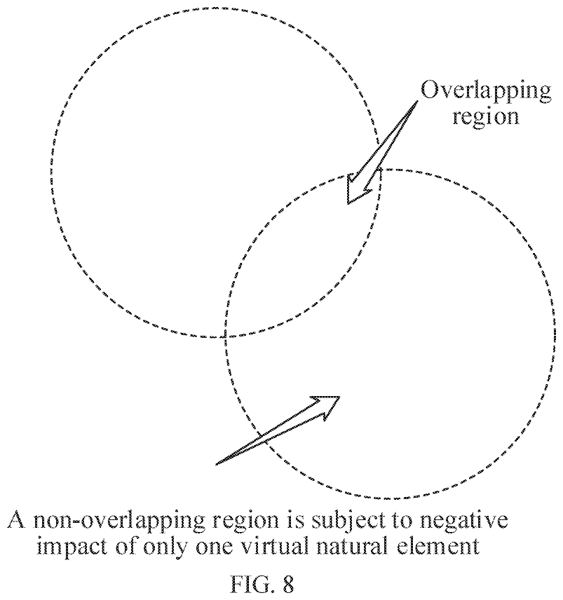

Exemplarily, FIG. 7 is a schematic diagram of a negative impact caused by a virtual natural element to a virtual object according to an embodiment of this application. Based on FIG. 7, when the virtual object is within a negative impact region of the virtual natural element, a first negative impact value caused by a virtual natural element shown in a dashed box 701 to the virtual object is displayed on a bottom of a map. In this way, the virtual object may be enabled to determine, in real time, the negative impact caused by the virtual natural element to the virtual object, thereby performing an appropriate solution for eliminating the negative impact. For example, if the first negative impact value is relatively high, the virtual object needs to find a supply as soon as possible for state supplementing. If the first negative impact value is relatively low, the virtual object continuously travels toward the virtual natural element. Herein, the first negative impact value may be compared with a preset negative impact threshold. When a comparison result represents that a current first negative impact value is greater than the negative impact threshold, it is determined that the current first negative impact value is larger. When the comparison result represents that the current first negative impact value is less than the negative impact threshold, it is determined that the current first negative impact value is smaller.

Through application of the foregoing embodiment, the first negative impact value configured for indicating the degree of obstruction caused by the virtual natural element to the movement of the virtual object within the negative impact region is displayed, so that the virtual object may sense in real time and determine the negative impact caused by the virtual natural element to the virtual object, thereby performing the appropriate solution for eliminating the negative impact in time, thereby improving efficiency of human-computer interaction and a utilization rate of hardware resources of an electronic device.

In some embodiments, when a plurality of virtual natural elements exist, first negative impact values caused by the plurality of virtual natural elements to the virtual object may be superimposed. When a plurality of virtual natural elements exist and negative impact regions of at least two of the plurality of virtual natural elements overlap, a corresponding overlapping region is determined. When the virtual object is in the overlapping region, for the at least two virtual natural elements that constitute the overlapping region, first negative impact values caused by the virtual natural elements are superimposed, to obtain a target first negative impact value for the virtual object. In this way, the target first negative impact value caused by the at least two virtual natural elements to the virtual object is displayed.

In a practical application, when the virtual object is in the overlapping region of the negative impact regions of the at least two virtual natural elements, the first negative impact values caused by the virtual natural elements are superimposed to obtain the target first negative impact value for the virtual object. In this way, a user who joins the virtual scene is enabled to better sense a position of the user, to improve a scene effect of the virtual scene and a sense of immersion of the user.

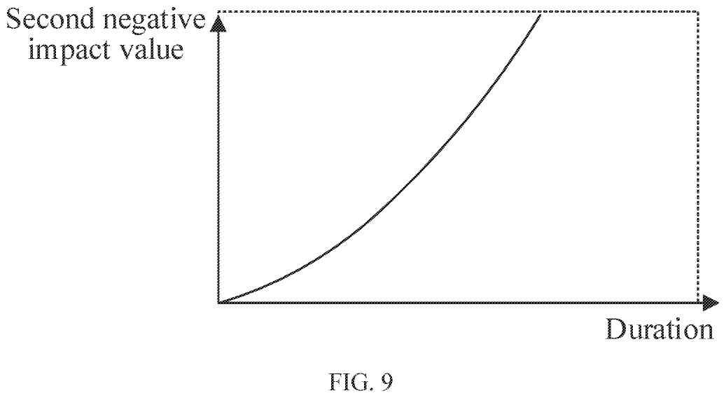

In addition to the first negative impact values caused to the virtual object, a negative impact caused by the plurality of virtual natural elements to an environment in which the virtual natural elements are located may also be superimposed. When a new virtual natural element is generated in the virtual scene and an overlapping region exists between a negative impact region of the generated new virtual natural element and the negative impact region of the virtual natural element, the new virtual natural element is displayed, and an effect of a virtual natural phenomenon within the overlapping region is enhanced. FIG. 8 is a schematic diagram of superimposition of negative impact regions of virtual natural elements according to an embodiment of this application. Based on FIG. 8, a non-overlapping region is subject to a negative impact of only one virtual natural element, and an overlapping region is subject to negative impacts of superimposition of two virtual natural elements. In addition, when the virtual object is in the overlapping region, a sum of first negative impact values corresponding to the two virtual natural elements is displayed.

Exemplarily, when a virtual natural phenomenon corresponding to the two virtual natural elements in the overlapping region is a virtual tornado, a light intensity in the overlapping region is less than that in the non-overlapping region of the negative impact regions, and damage to a virtual object is greater than that in the non-overlapping region of the negative impact regions. Alternatively, when virtual natural phenomena corresponding to the two virtual natural elements in the overlapping region are a virtual tornado and a virtual volcano, the virtual natural phenomenon corresponding to the virtual tornado and the virtual natural phenomenon corresponding to the virtual volcano both exist in the overlapping region, and the damage to the virtual object is greater than that in the non-overlapping region of the negative impact regions.

Through application of the foregoing embodiment, when the virtual object is in the overlapping region of the negative impact regions of the at least two virtual natural elements, the negative impact caused to the environment in which the virtual natural elements are located is superimposed. In this way, a user who joins the virtual scene can better sense a position of the user, to improve a scene effect of the virtual scene and a sense of immersion of the user, thereby improving efficiency of human-computer interaction and a utilization rate of hardware resources of an electronic device.

In some embodiments, in addition to the negative impact caused by the virtual natural element to the virtual object, when the virtual object is not within the negative impact region of the virtual natural element, the virtual object also has a negative impact value, and a duration of the virtual object in the virtual scene is obtained. A second negative impact value of the virtual object is dynamically displayed. The second negative impact value is positively correlated with the duration. The second negative impact value is configured for indicating a degree of obstruction (i.e., a magnitude of the obstruction) caused to movement of the virtual object within the virtual scene. The second negative impact value caused to the virtual object herein is configured for indicating a negative impact caused to a state value of the virtual object, for example, reduce a traveling speed of the virtual object, or reduce a health point of the virtual object. Exemplarily, FIG. 9 is a schematic diagram of a relationship between a second negative impact value and a duration according to an embodiment of this application. Based on FIG. 9, a longer time for which a virtual object is in a virtual scene leads to a faster growth rate of the second negative impact value.

In a practical application, in addition to the negative impact caused by the virtual natural element to the virtual object, when the virtual object is not within the negative impact region of the virtual natural element, a negative impact value associated with the duration of the virtual object in the virtual scene also exists. In this way, enthusiasm of the user to eliminate the negative impact and a sense of immersion of the user are improved.

During an actual implementation, the second negative impact value is a value of a negative impact caused by a global impact source of the virtual scene to the virtual object, and the global impact source has a hidden attribute and an upgrade attribute. The upgrade attribute enables the global impact source to have at least two stages including a first stage and a second stage. The first stage corresponds to a first correlation coefficient between the second negative impact value and the duration, and the second stage corresponds to a second correlation coefficient between the second negative impact value and the duration. A value of the second correlation coefficient is greater than a value of the first correlation coefficient. When it is determined that the global impact source is in the first stage, a process of dynamically displaying the second negative impact value of the virtual object includes: obtaining an initial value of the negative impact caused by the global impact source to the virtual object, and multiplying the initial value by the value of the first correlation coefficient, to obtain a second negative impact value; dynamically displaying the second negative impact value; multiplying the initial value by the value of the second correlation coefficient when it is determined that the global impact source progresses from the first stage to the second stage, to obtain a target negative impact value; and adjusting the displayed second negative impact value to the target negative impact value.

Through application of the foregoing embodiment, the growth rate of the negative impact value is changed through the duration of the virtual object in the virtual scene. In this way, diversity of interactive processes in the virtual scene is increased, and the enthusiasm of the user to eliminate the negative impact are improved, thereby improving efficiency of human-computer interaction and a utilization rate of hardware resources of an electronic device.

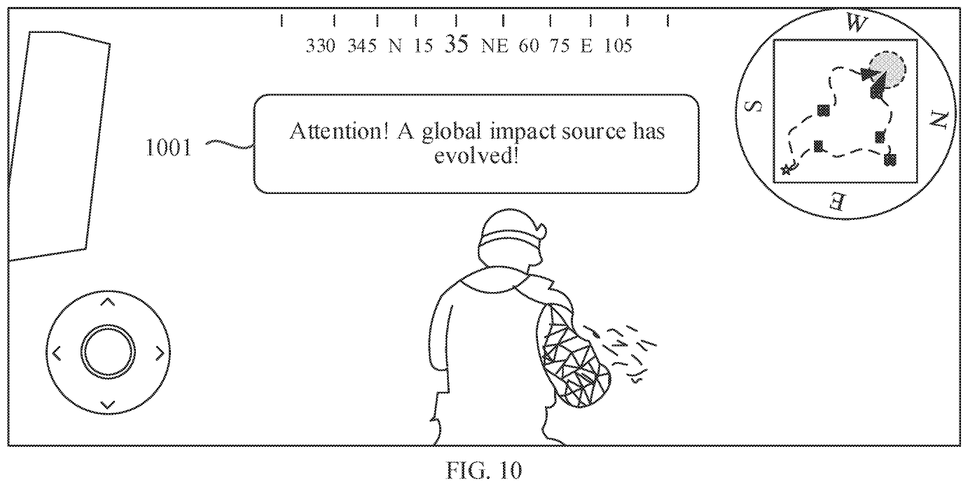

When it is determined that the global impact source progresses from the first stage to the second stage, upgrade prompt information corresponding to the global impact source is also displayed, and the duration of the virtual object in the virtual scene is obtained. When it is determined based on the duration that the global impact source progresses from the first stage to the second stage, the upgrade prompt information corresponding to the global impact source is displayed. The upgrade prompt information is configured for prompting that the global impact source has been upgraded. Exemplarily, FIG. 10 is a schematic diagram of upgrade prompt information of a global impact source according to an embodiment of this application. Based on FIG. 10, when it is determined based on a duration that a global impact source progresses from a first stage to a second stage, upgrade prompt information shown in a box 1001 is displayed.

For a process of determining based on the duration that the global impact source progresses from the first stage to the second stage, a target duration threshold corresponding to the second stage is preset herein, so that the duration is compared with the target duration threshold to determine that the global impact source has been upgraded from the first stage to the second stage. The obtained duration is compared with the target duration threshold. When a comparison result represents that the duration is greater than the target duration threshold, it is determined that the global impact source has been upgraded from the first stage to the second stage.

In an actual application, the upgrade prompt information configured for prompting that the virtual natural element has been upgraded is displayed, and the user is reminded in time that the growth rate of the negative impact value has been increased, thereby improving interactive experience of the user.

During an actual implementation, the first negative impact value and the second negative impact value of the virtual object may also be superimposed. When the virtual object is within the negative impact region of the virtual natural element, the first negative impact value caused by the virtual natural element to the virtual object and the second negative impact value caused by the global impact source to the virtual object are determined. The first negative impact value and the second negative impact value are superimposed to obtain a total negative impact value of the virtual object, and the total negative impact value of the virtual object is dynamically displayed.

The total negative impact value of the virtual objects also has an upper limit, thereby avoiding overflow of negative impact effects after the superimposition. In addition, the total negative impact value of the virtual object may also represent strength of the virtual natural phenomenon of a position of the virtual object in the virtual scene, thereby rendering an environment atmosphere and enhancing a sense of substitution of the user.

During an actual implementation, before the virtual object and the virtual natural element belonging to the virtual natural phenomenon are displayed in the virtual scene, a quantity of virtual natural elements may further be determined. Herein, a plurality of manners of determining the quantity of virtual natural elements are provided. Next, a process of determining the quantity of virtual natural elements is described by using two determination manners as an example.

In some embodiments, level options respectively corresponding to at least two difficulty levels are displayed. Different difficulty levels correspond to different quantities of virtual natural elements. The at least two difficulty levels include a target difficulty level, and the target difficulty level corresponds to a target quantity of virtual natural elements. In response to a selection operation on a level option for the target difficulty level, the target quantity of virtual natural elements is determined, so that the virtual object and the target quantity of virtual natural elements belonging to the virtual natural phenomenon are displayed in the virtual scene.

In some other embodiments, when the quantity of virtual natural elements is preset, the target quantity of the virtual natural elements in the virtual scene is directly obtained, so that the virtual object and the target quantity of virtual natural elements belonging to the virtual natural phenomenon are displayed in the virtual scene.

During an actual implementation, before initialization of the virtual scene, a relevant developer determines alternative positions of the at least two virtual natural elements in the virtual scene, and then selects, based on the determined target quantity of virtual natural elements, alternative positions corresponding to the quantity of virtual natural elements from the alternative positions of the at least two virtual natural elements as positions for the virtual natural elements to be displayed. In this way, the virtual object is displayed in the virtual scene, and the virtual natural elements belonging to the virtual natural phenomenon are displayed on the selected positions. Herein, to avoid positions of the virtual natural elements that enter virtual scenes with the same difficulty level being the same, the alternative positions corresponding to the quantity of virtual natural elements may be randomly selected from the alternative positions of the at least two virtual natural elements as the positions for the virtual natural elements to be displayed.

Consideration factors in determining the alternative positions of the virtual natural elements from the virtual scene include but are not limited to a distance between each alternative position and a birth point of the virtual object, a distance between each alternative position and an NPC in the virtual scene, and the like. In addition, for different virtual scenes or virtual scenes with different difficulty levels, quantities of alternative positions of the virtual natural elements may be different.

Operation 102: Control the virtual natural element to be transformed into an interactive target object when the virtual object is within a sensing region of the virtual natural element, a negative impact region of the virtual natural element including the sensing region.

The sensing region of the virtual natural element may be a circular region with a position of the virtual natural element as a center and a target distance as a radius. The target distance herein is preset, for example, 5 meters. However, the negative impact region is a region in which the virtual natural element causes the negative impact to the environment in which the virtual natural element is located. The sensing region may be the same or different from the negative impact region. For example, the sensing region may be within a region range of the negative impact region. For example, the sensing region may be the circular region with the position of the virtual natural element as the center and the target distance of 5 meters as the radius, and the negative impact region may be a circular region with the position of the virtual natural element as the center and a target distance of 7 meters as the radius.

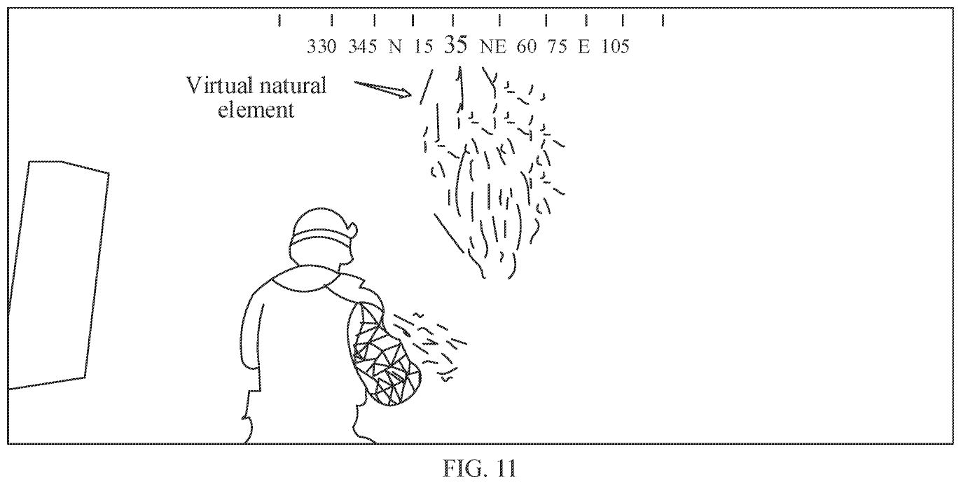

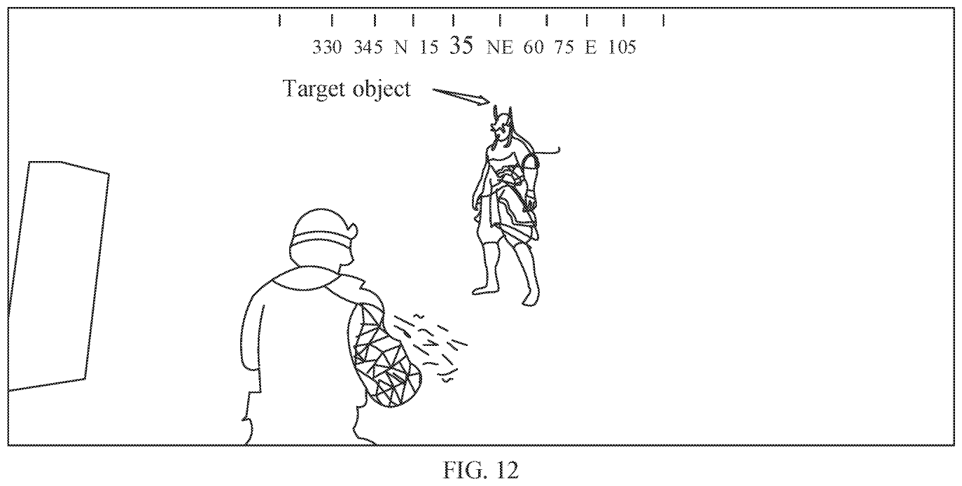

Exemplarily, FIG. 11 is a schematic diagram of a virtual natural element according to an embodiment of this application, and FIG. 12 is a schematic diagram of a target object according to an embodiment of this application. Based on FIG. 11 and FIG. 12, after a virtual object enters a sensing region of a virtual natural element, the virtual natural element is transformed into a target object as shown in FIG. 12.

In some embodiments, after the virtual natural element is transformed into an interactive target object, the target object chases the virtual object in the sensing region, and a search picture in which the target object searches the virtual scene for the virtual object is displayed. When the target object does not find the virtual object within the sensing region within a target duration, the target object is controlled to be transformed into the virtual natural element. However, a case in which the target object finds the virtual object is to be described in operation 103.

Since the target object chases the virtual object, a position of the virtual natural element also moves with movement of the target object, thereby ensuring that the position of the virtual natural element is consistent with that of the target object.

Through application of the foregoing embodiment, after the virtual natural element is transformed into the interactive target object, the target object chases the virtual object within the sensing region. When the target object does not find the virtual object, the target object is transformed into the virtual natural element. In this way, diversity of interactive processes in the virtual scene is increased, and interactive experience of users is improved, thereby improving efficiency of human-computer interaction and a utilization rate of hardware resources of an electronic device.

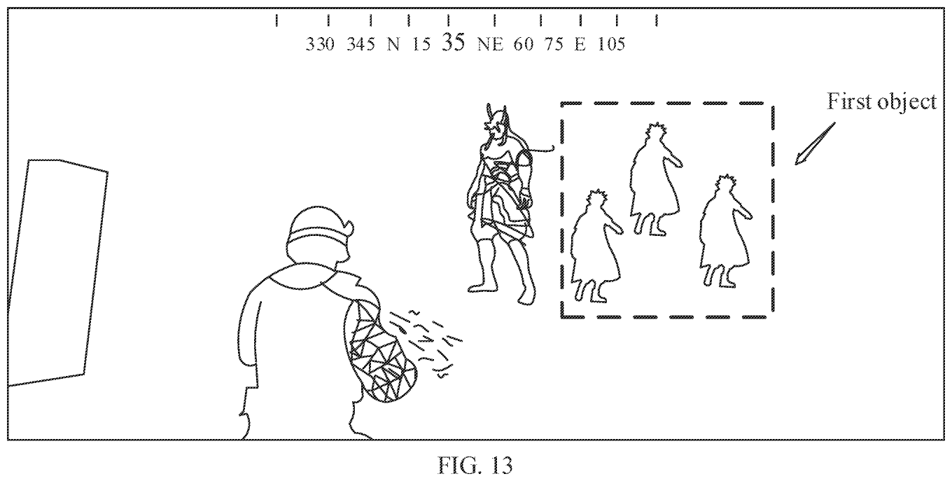

In some embodiments, when the virtual object is within the sensing region of the virtual natural element, at least one interactive first object in an idle state is further generated. FIG. 13 is a schematic diagram of a first object according to an embodiment of this application. Based on FIG. 11 and FIG. 13, after the virtual object enters the sensing region of the virtual natural element, a first object as shown in FIG. 13 is further generated at the position of the virtual natural element in the virtual scene while the virtual natural element is transformed into the interactive target object.

The idle state herein is configured for indicating a non-interactive state such as a non-battle state. To be specific, the first object does not actively chase the virtual object but is configured to interfere with the virtual object. The interactive state is configured for indicating that the first object actively chases the virtual object. Based on this, the virtual object may choose whether to interact with the first object. When the virtual object chooses to interact with the first object, the first object interacts with the virtual object. In response to an interaction instruction for the virtual object, the virtual object is controlled to interact with the first object in the virtual scene. The interaction is configured for transforming the first object from the idle state to the interactive state.

In an actual application, when the virtual object is within the sensing region of the virtual natural element, the at least one interactive first object in the idle state is generated. The virtual object may choose whether to interact with the first object. When the virtual object chooses to interact with the first object, the first object interacts with the virtual object. In this way, diversity of interactive objects and interactive modes in the virtual scene is increased, and interactive experience of the users is improved.

During an actual implementation, an object type of the first object corresponds to a level of the virtual object. Based on the level of the virtual object, a process of generating the first object includes: obtaining the level of the virtual object when the virtual object is within the sensing region of the virtual natural element, and determining the object type corresponding to the level based on the level; and generating the at least one interactive first object in the idle state based on the object type.

For the process of determining the object type corresponding to the level based on the level, a correspondence between the level and the object type is preset herein. The object type of the first object herein includes but is not limited to the level and a shape of the first object. For example, when the level of the virtual object is a high level, a first high-level object is generated, and when the level of the virtual object is a low level, a first low-level object is generated. Alternatively, when the level of the virtual object is the high level, a first object with a flying ability is generated, and when the level of the virtual object is the low level, a first object without the flying ability is generated. Based on this, the process of determining the object type corresponding to the level based on the level may be obtaining the correspondence between the level and the object type, and determining the object type corresponding to the level based on the level and the correspondence.

Through application of the foregoing embodiment, the object type corresponding to the level is determined based on the level, to generate at least one interactive first object in the idle state corresponding to the object type. In this way, diversity of interactive processes in the virtual scene is increased, and the enthusiasm of the user to upgrade the level is improved, thereby improving efficiency of human-computer interaction and a utilization rate of hardware resources of an electronic device.

During an actual implementation, after the virtual object kills all of the first objects, a virtual resource that is used as a reward and can be applicable to the virtual scene may be displayed in the virtual scene. Exemplarily, the virtual resource may be a supply configured to reduce a negative impact value of the virtual object, a prop configured to perform an interactive operation on the target object, an experience point for improving the level of the virtual object, or the like.

In some embodiments, after the virtual natural element is transformed into the target object, the virtual object may also be moved out of the sensing region of the target object, so that the target object cannot sense the virtual object and is thus transformed again into the virtual natural element. In response to a region leaving operation for the virtual object, the virtual object is controlled to leave the sensing region. When a duration for which the virtual object is out of the sensing region reaches a target duration, the target object is controlled to be transformed into the virtual natural element.

After the target object is transformed into the virtual natural element, when the virtual object does not interact with the first object or does not kill all of the first objects, the first object in the virtual scene also disappears.

Operation 103: Control the virtual object to interact with the target object in the virtual scene when an interaction instruction for the target object is received.

During an actual implementation, for a case in which the target object finds the virtual object, since the target object chases the virtual object, based on this, when the interaction instruction for the target object is received, a process of controlling the virtual object to interact with the target object in the virtual scene includes: displaying a search picture in which the target object searches the virtual scene for the virtual object; and controlling the virtual object to interact with the target object in the virtual scene when the target object finds the virtual object and performs the interactive operation on the virtual object and the interaction instruction for the target object is received.

In an actual application, after the virtual natural element is transformed into the interactive target object, the target object chases the virtual object in the sensing region. The target object actively interacts with the virtual object when finding the virtual object. In this way, diversity of the interactive processes in the virtual scene is increased, and enthusiasm of the user to interact with the target object the user is improved.

In some embodiments, after the target object is controlled to perform an interactive operation on the virtual object or the virtual object is controlled to interact with the target object, the virtual object may also hide based on a virtual building in the virtual scene, so that the target object cannot sense the virtual object and is thus transformed again into the virtual natural element. In response to a hiding instruction for the virtual object, the virtual object is controlled to be transformed from an interactive state to a hidden state. The hidden state causes the target object to be unable to sense the virtual object. A picture in which the target object searches the virtual scene for the virtual object is displayed. When the target object does not find the virtual object in the hidden state within the target duration, the target object is controlled to be transformed into the virtual natural element. Since the virtual object is transformed from the interactive state to the hidden state, the target object moves toward and searches for the last position where the virtual object appears. A process of displaying the picture in which the target object searches the virtual scene for the virtual object may be displaying position movement during state transition of the target object to the virtual object, and the picture in which the target object searches the virtual scene for the virtual object.

Exemplarily, if the target object suddenly cannot sense the virtual object during interaction with the virtual object (for example, if the virtual object hides behind a wall, the target object loses sight of the virtual object), the target object searches, at a movement speed in a state of alert, for the last position where the virtual object disappears, and then is actively transformed into a form of the virtual natural element if the virtual object or a new virtual object cannot be found after a preset target duration.

Through application of the foregoing embodiment, after the target object is controlled to perform an interactive operation on the virtual object or the virtual object is controlled to interact with the target object, the virtual object may further be hidden based on the virtual building in the virtual scene, so that the target object cannot sense the virtual object and is thus transformed again into the virtual natural element. In this way, diversity of the interactive modes in the virtual scene is increased, and interactive experience of the user is improved, thereby improving efficiency of human-computer interaction and a utilization rate of hardware resources of an electronic device.

In some embodiments, after the virtual object is controlled to interact with the target object, the virtual object may also be moved out of the sensing region of the target object, so that the target object cannot sense the virtual object and is thus transformed again into the virtual natural element. In response to a region leaving operation performed on the virtual object, the virtual object is controlled to leave the sensing region. When a duration for which the virtual object is out of the sensing region reaches a target duration, the target object is controlled to be transformed into the virtual natural element.

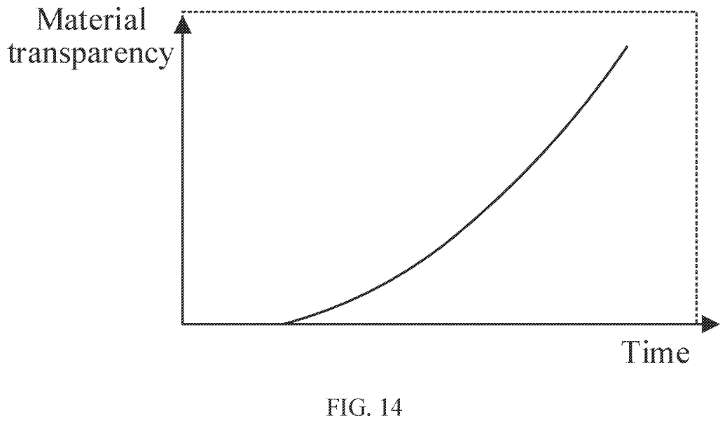

During an actual implementation, controlling the transformation of the target object into the virtual natural element is a gradual process over time. The target object gradually becomes transparent from a first end to a second end over time, and the virtual natural element is gradually displayed from the second end to the first end over time. A rate of displaying and a rate of becoming transparent are both positively correlated with time. Exemplarily, FIG. 14 is a schematic diagram of a process of transforming a target object into a virtual natural element according to an embodiment of this application. Based on FIG. 14, when the target object is transformed into the virtual natural element, a model material of the target object becomes transparent over time. Herein, a gradual change in material transparency may be implemented with a special effect, for example, a bottom-to-top or top-to-bottom effect that the target object is rendered gradually transparent from bottom to top or from top to bottom, and at the same time, the virtual natural element is correspondingly rendered gradually untransparent and displayed. For the process of transforming the virtual natural element into the target object, a process of controlling the model material of the target object from hiding to displaying exists, which is a reciprocal process to the foregoing process. To be specific, the virtual natural element is rendered gradually transparent from bottom to top or from top to bottom, and at the same time, the target object is correspondingly rendered gradually untransparent and displayed.

After the target object is transformed into the virtual natural element, once the virtual object around the virtual natural element reenters the sensing region, the virtual natural element is transformed into the target object again, and the first object may also be generated. Herein, types and the quantity of the target objects and the first objects that appear are also refreshed. Herein, protection of a target duration exists in the process of transforming the target object into the virtual natural element. Timing is started from a transformation moment of the target object, and within this target time, sensing of the target object is disabled. Even if the virtual object approaches the target object or the virtual natural element again, the transformation process from the target object to the virtual natural element is not immediately interrupted, and the virtual natural element just transformed is not to be transformed into the target object again. In this way, an abnormal situation in which transformations between the virtual natural element and the target object repeat may be avoided when an extreme case occurs in which the virtual object repeatedly jumps across an edge of the sensing region.

In some embodiments, after the virtual object interacts with the target object, the virtual object may further kill the target object. When the virtual object kills the target object, a virtual resource used as a reward is displayed in the virtual scene. The virtual resource is configured to be applied to the virtual scene. Exemplarily, the virtual resource may be a supply configured to reduce a negative impact value of the virtual object, a prop configured to perform an interactive operation on the target object, an experience point for improving the level of the virtual object, or the like.

In an actual application, when the virtual object kills the target object, the virtual resource used as the reward is displayed in the virtual scene. In this way, diversity of the interactive processes in the virtual scene is increased, and enthusiasm of the user to kill the target object is enhanced.

During an actual implementation, when the virtual object kills the target object, a negative impact within the negative impact region caused by the virtual natural element is eliminated radiatively at a preset rate with a position of the target object as a center. Exemplarily, when the virtual natural phenomenon corresponding to the virtual natural element is a virtual tornado, after the virtual object kills the target object, a light intensity within the negative impact region is enhanced from near to far from the foot of the target object in the form of water ripples or light rays with the position of the target object as the center, and damage caused by the virtual tornado to the virtual object within the negative impact region is repaired.

Through application of the above embodiment, when the virtual object kills the target object, a negative impact within the negative impact region caused by the virtual natural element is eliminated radiatively at a preset rate with a position of the target object as a center. In this way, diversity of the interactive processes in the virtual scene is increased, and a sense of immersion and interactive experience of the user are improved.

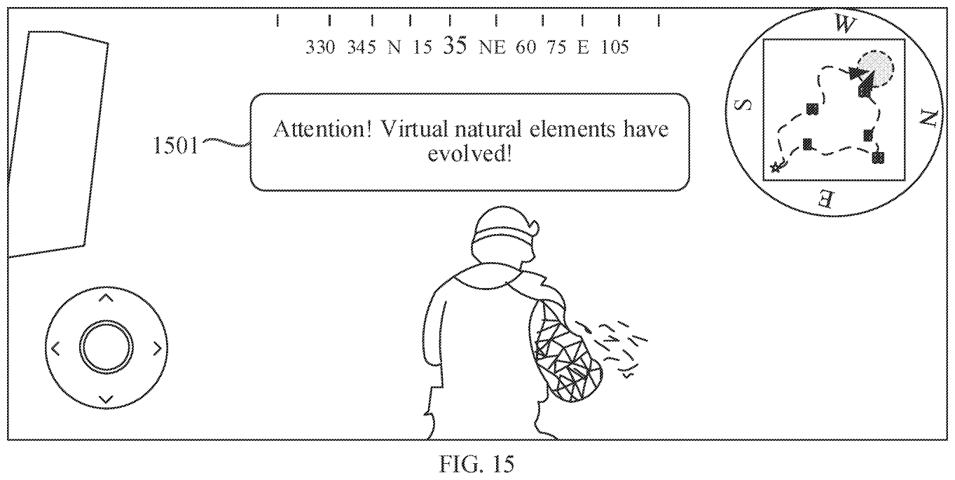

In some embodiments, the virtual natural element also has the upgrade attribute, and a difference exists between state attributes of interactive target objects transformed from an upgraded virtual natural element and a non-upgraded virtual natural element. When an upgrade condition of the virtual natural element is satisfied, upgrade prompt information corresponding to the virtual natural element is displayed. The upgrade prompt information is configured for prompting that the virtual natural element has been upgraded, and an upgraded object obtained through transformation of the upgraded virtual natural element satisfies at least one of the following conditions: a health point is greater than a health point of the target object; and damage caused to the virtual object by performing an interactive operation is higher than damage caused to the virtual object by performing the interactive operation by the target object. Exemplarily, FIG. 15 is a schematic diagram of upgrade prompt information of a virtual natural element according to an embodiment of this application. Based on FIG. 15, when an upgrade condition of the virtual natural element is satisfied, upgrade prompt information shown in a box 1501 is displayed.

The upgrade condition of the virtual natural element includes but is not limited to a duration of the virtual object in the virtual scene or a quantity of virtual natural elements. When the duration of the virtual object in the virtual scene satisfies a target duration, it is determined that the upgrade condition of the virtual natural element is satisfied. Alternatively, since the quantity of the corresponding virtual natural elements decreases after the virtual object kills the target object, when the quantity of virtual natural elements is less than a target quantity, the upgrade condition of the virtual natural element is satisfied. Herein, the first object may also be upgraded with the upgrading of the virtual natural element, and the upgraded first object has the same characteristics as the foregoing upgraded target object.

A longer duration of the virtual object in the virtual scene or a smaller quantity of virtual natural elements indicates a faster upgrading speed of the virtual natural element. Herein, a number of upgrades of the virtual natural element and a health point of the target object and a bonus multiplier of the damage caused to the virtual object by performing the interactive operation after each upgrade may be preset. When the upgrade condition of the virtual natural element is satisfied, the transformed target object and the first object are not upgraded. To be specific, health points of the transformed target object and the first object and the damage caused to the virtual object by performing the interactive operation do not change.

In some embodiments, during advancing from the virtual object to the virtual natural element, an interactive second object may also be presented. In response to a movement instruction for the virtual object, the virtual object is controlled to move toward the virtual natural element, and the interactive second object is displayed in the virtual scene. Herein, the second object is an interactive object in the virtual scene that is unrelated to the virtual natural element. In addition, the second object also chases the virtual object, and with an increase in the duration, a health point of the second object and the damage caused to the virtual object by performing the interactive operation also increase.

In an actual application, during traveling of the virtual object toward the virtual natural element, the interactive second object is presented. In this way, diversity of the interactive objects and the interactive modes in the virtual scene is increased, and interactive experience of the user is improved, thereby improving efficiency of human-computer interaction and a utilization rate of hardware resources of an electronic device.

During an actual implementation, when the virtual object does not enter the negative impact region, a picture in which the second object searches the virtual scene for the virtual object is displayed. When the second object finds the virtual object and performs the interactive operation on the virtual object, the virtual object is controlled to interact with the second object in the virtual scene in response to the interaction instruction for the virtual object. However, when the virtual object enters the negative impact region, the virtual object is marked, and the virtual object carrying a mark is displayed. The mark is configured for causing the second object to be unable to find the virtual object, thereby ensuring that the virtual object entering the negative impact region is not interfered by the second object.

Through application of the foregoing embodiment, the virtual object is marked, so that the second object cannot find the virtual object, thereby ensuring that the virtual object entering the negative impact region is not interfered by the second object. In this way, diversity of the interactive processes in the virtual scene is increased, and interactive experience of the user is improved.

When the virtual object kills the second object, a virtual resource that is used as a reward and can be applicable to the virtual scene may also be displayed in the virtual scene. Exemplarily, the virtual resource may be a supply configured to reduce a negative impact value of the virtual object, a prop configured to perform an interactive operation on the target object, an experience point for improving the level of the virtual object, or the like.

The embodiments of this application relate to related data such as a triggering operation of a user and user information. User permission or consent needs to be obtained when the embodiments of this application are applied to specific products or technologies, and the collection, use, and processing of related data need to comply with relevant laws, regulations, and standards of relevant countries and regions.

Through application of the foregoing embodiments of this application, the virtual object and the virtual natural element that causes the negative impact to the virtual environment in the virtual scene are displayed in the virtual scene. When the virtual object enters the negative impact region of the virtual natural element, the virtual natural element is transformed into the target object for the virtual object to interact with, so that the virtual object interacts with the target object. In this way, when the virtual object is close to the virtual natural element, during transformation of the virtual natural element into the interactive object to implement the interactive process, which enriches interactive objects during free exploration, reduces an exploration time, and also improves the efficiency of the human-computer interaction and the utilization rate of hardware resources of the electronic device while increasing the diversity of interactive objects in the virtual scene.

Next, an exemplary application of this embodiment of this application in an actual application scenario is to be described.

In the related art, a player in an open game world lacks direction guidance to find various random tasks, which may lead to repeated and meaningless moving on the map, and even brushing past a task object. In addition, due to lack of sufficient filling content, when the player quickly finds and kills a game target, a game duration ends prematurely, which may cause the game content to be consumed faster than expected. Moreover, actual game task types are generally dominated by monotonous experiences such as dialogues and collection, which lacks specific packaging and creation of an atmosphere of a sense of substitution of an open world.

Based on the above, embodiments of this application provide an interaction method in a virtual scene. Several player (virtual object)-selectable sub-events, i.e., undercurrent pollution sources (virtual natural elements) are created on a map, a player is guided to challenge a closest undercurrent pollution source in a big map when feeling confused about a target. The undercurrent pollution source is transformed into a monster (a target object) to fight against the player when the player approaches, and the player may obtain rich rewards as long as the player succeed in the challenge. In this way, loss of the player is avoided while enriching the game experience.

During an actual implementation, the interaction method in a virtual scene provided in the embodiments of this application focuses on optimizing the following experiences: 1. A specific quantity of undercurrent pollution sources are randomly generated in the open world. 2. A system can guide a player to find a nearest pollution source at any moment by using a small radar (a map). 3. The undercurrent pollution source is a dangerous region like a tornado at a default moment. When a player approaches, the undercurrent pollution source is transformed into a configured monster of a specified type to fight against the player. 4. The player may win, purify a pollution source, and get rich rewards provided that the player defeats a key monster of a specified type. 5. When the player chooses to be removed from the battle with the key monster, the key monster returns to a state of the undercurrent pollution source at a current position. 6. As a single round progresses, pollution sources in the entire map improve slowly, and intensity increases.

Next, the interaction method in a virtual scene provided in the embodiments of this application is described from a product side.

First, a basic process is introduced: 1. In a full-level map, there are a plurality of undercurrent pollution sources at different intensities (discrete levels). 2. The undercurrent pollution source radiates an undercurrent value (a first negative impact value) to a player within a specific range (a negative impact region) around. Undercurrent value multipliers at positions at different distances from the pollution sources may be defined by using a curve. 3. When a player approaches the pollution source within a specific range (a sensing region), the pollution source is materialized as a key monster (a target object), which has a wide range of perception and chases the player. 4. When the pollution source is transformed into the key monster state, a center of the pollution source moves with the key monster to ensure a consistent position. 5. Every time a player cleans up a pollution source by killing a key monster, the player purifies a region affected by the pollution source and gets a reward (a virtual resource) corresponding to the pollution source, the reward falling when the key monster dies. 6. When the undercurrent pollution source is cleared, a purification effect from near to far is produced. 7. The same undercurrent pollution source may be defined by using a curve. Intensity of the undercurrent pollution source changes over time, and undercurrent values radiated to surrounding players change. 8. A huge global undercurrent pollution source (a global impact source) exists in a level, which radiates undercurrent values to players in the entire map and varies with the time of a single round by using a curve. This undercurrent pollution source has no center, no entity, no warning, and the like. 9. In a single round, an undercurrent value (a target negative impact value) is maintained for each player. The undercurrent value may be a sum of radiation values from the pollution sources for a position where a current player is located (for example, a single pollution source plus a global pollution source). 10. The undercurrent value of each player has an upper limit (such as 100), to avoid an overflow effect when a plurality of pollution sources overlap. 11. A real-time undercurrent value of the player represents strength of undercurrent concentration at a current position where the player is located, and reflects a dark region effect (a virtual natural phenomenon) of a client, to be rendered as a world view atmosphere, to improve a sense of immersion into a big world game. 12. The undercurrent value of the player is displayed in real time below a radar in the upper right corner, as shown in FIG. 7. 13. The undercurrent pollution source transmits a mark to all players within a specific range around, to ensure that the player entering the range is not interfered by an irrelevant monster (a second object). 14. A player in a non-pollution source radiation region (a non-negative impact region) is still affected by a dynamic monster spawning system, and as a single round progresses, a specific quantity of monsters (second objects) are generated to fight against the player.

Then, interactive gameplay of the undercurrent pollution sources is described. 1. In level planning, several generation points (target locations) of undercurrent pollution sources in levels may be placed in advance. 2. During initialization of the levels, [a, b] (a target quantity of) positions (a≤b) are randomly selected from the preset points (alternative positions) as the generation points of the undercurrent pollution sources. During configuration in planning, it needs to be ensured that a total quantity of preset points n≥b. Herein, assuming that a case in which n<a occurs, a relevant operation is performed by using a logic of activating all of the n positions. 3. Different levels may support different configurations of the interval [a, b]. 4. A rule is set for selection of the preset points in subsequent iterations. Consideration factors include but are not limited to a distance between each preset point and a birth point of a character (a virtual object), and a distance between each preset point and a level target. 5. As a single round progresses, after a specific interval of t seconds (a target duration), the global undercurrent pollution source triggers an evolution. The evolution results in all monsters obtaining a specific additional magnification of health points (hit points) and attack power (damage caused to the virtual object by performing an interactive operation) during generation of next trigger. 6. A total quantity of evolutions of the undercurrent pollution sources and a bonus multiplier of corresponding health points and attack power after each evolution may be pre-configured. 7. If the undercurrent pollution source has generated a batch of monsters (target objects and/or first objects) during triggering of the evolution, the batch of monsters are not affected by the evolution and are to be affected until a next evolution. 8. Each time a global evolution is triggered, interface prompts need to be provided to all players, as shown in FIG. 10. 9. The undercurrent pollution source is only a special tornado effect on a performance level without collision under normal conditions. 10. When a player approaches an R-meter pollution source (a sensing region), the pollution source generates specified types and quantities of monster groups (first objects) within a unit, and the original central tornado effect is transformed into a key monster (the target object). 11. Killing the key monster may cause explosion of the pollution source, purify the nearby region, and obtain a falling reward (only one key monster is defined herein to prevent a tricky case in which when a plurality of key monsters exist, the player kills a part of the key monsters and triggers a disengagement logic, and the key monsters revive). 12. As mentioned above, when the key monster is generated, the position of the pollution source is consistent with that of the key monster all the time. 13. Other monsters (the first objects) in the monster group only serves as interference, and the player may choose to kill or not to kill the other monsters, which does not affect cleaning of the pollution source. 14. All of the generated monsters (the target objects and the first objects) of the pollution source enter an idle state once the disengagement logic is triggered. If no player appears within a target range in the entire state, the key monster returns to the pollution source state (non-entity), and the pollution source uses a current position as a center. 15. After the key monster returns to the pollution source state, once other players around the pollution source re-enter the R-meter range, generation is triggered again, and all generated monsters of the specified type and quantity are also refreshed. 16. It may be considered that a state of the tornado (non-entity) at the center of the pollution source and a state of the key monster are mutually transformable. 17. The undercurrent pollution source may be purified and rich rewards may be obtained provided that the player kills the key monster. 18. The player may freely choose to kill or not kill interference monsters (first objects and/or second objects) allow, without affecting outcome determination.

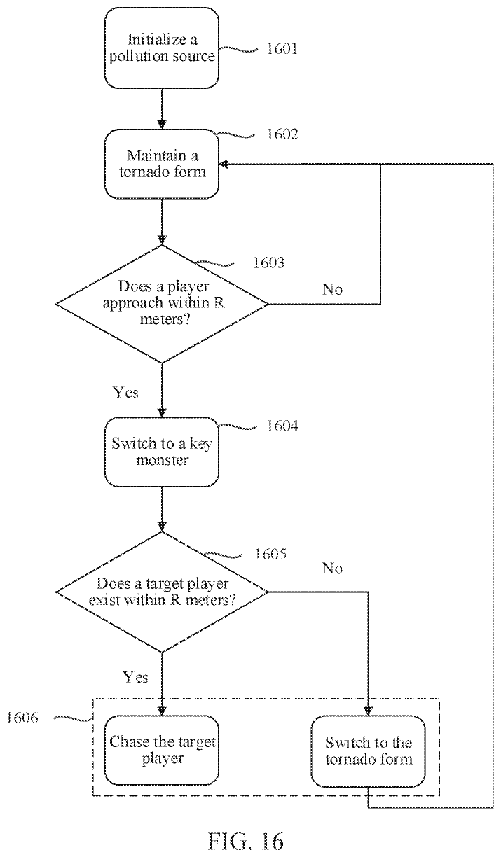

Next, the interaction method in a virtual scene provided in the embodiments of this application is described from a technical side. First, FIG. 16 is a flowchart of a transformation logic between a pollution source and a key monster according to an embodiment of this application. Based on FIG. 16, the interaction method in a virtual scene provided in the embodiments of this application is implemented by using operation 1601 to operation 1606. When a pollution source tornado and a key monster are transformable, 1. it needs to be detected constantly that no player exists within an R radius with a current position as a center; 2. a key monster needs to be in a non-battle state, i.e., a target is lost or dead, and no other targets that may be used as battle objects exist around; 3. if the key monster suddenly loses sight of the target (a virtual object) in a battle (for example, the target hides behind a wall), the key monster searches for the last place where the target disappears with an animation and a movement speed in a state of alert, this state lasts for a preset t seconds, and if the old target or a new target cannot be found after t seconds, the key monster returns to a normal idle state and then actively transforms into an undercurrent pollution source form; 4. during transformation to the tornado state, a model material of the key monster needs to experience a process of slowly hiding over time, is controlled by a function curve, and is regenerated around in cooperation with the tornado, as shown in FIG. 14; 5. a gradual change in material transparency may be implemented with a special effect, for example, a bottom-to-top effect that the target is rendered gradually transparent from bottom to top through a mask or is rendered gradually untransparent and displayed; 6. a curve in which a function controls a model material of a monster from hiding to displaying also exists during transformation of the tornado to the key monster; and 7. if protection of a T duration is provided during transformation from the key monster to the pollution source after disengagement, timing is started from a moment of monster transformation, and perception of the monster is disabled within the T time, so that even if a player approaches the monster or the pollution source again, the transformation process from the monster to the pollution source is not immediately interrupted, and an undercurrent center that has just been transformed into the pollution source becomes the monster again. In this way, an abnormal situation in which transformations between the undercurrent and the monster repeat may be avoided when an extreme case occurs in which the player repeatedly jumps across an edge of the undercurrent.

Through application of the foregoing embodiments of this application, the virtual object and the virtual natural element that causes the negative impact to the virtual environment in the virtual scene are displayed in the virtual scene. When the virtual object enters the negative impact region of the virtual natural element, the virtual natural element is transformed into the target object for the virtual object to interact with, so that the virtual object interacts with the target object. In this way, when the virtual object is close to the virtual natural element, the virtual natural element is transformed into the interactive object to implement the interactive process, which enriches interactive objects during free exploration, reduces an exploration time, i.e., reduces a time for performing a human-computer interaction operation to implement the interactive process, thereby improving the efficiency of the human-computer interaction and a utilization rate of hardware resources of the electronic device.

An exemplary structure of the interactive apparatus 455 in a virtual scene provided in the embodiments of this application implemented as a software module continues to be described below. In some embodiments, as shown in FIG. 2, the software module in the interactive apparatus 455 in a virtual scene stored in a memory 440 may include:
a display module 4551, configured to display a virtual object and a virtual natural element belonging to a virtual natural phenomenon in a virtual scene, the virtual natural element being configured to cause a negative impact to an environment in which the virtual natural element is located;
a first control module 4552, configured to control the virtual natural element to be transformed into an interactive target object when the virtual object is within a sensing region of the virtual natural element, a negative impact region of the virtual natural element including the sensing region; and
a second control module 4553, configured to control the virtual object to interact with the target object in the virtual scene when an interaction instruction for the target object is received.

In some embodiments, the apparatus further includes a first display module. The first display module is configured to display a map of the virtual scene, and dynamically display a relative positional relationship between the virtual object and the virtual natural element on the map.

In some embodiments, the first display module is further configured to dynamically display a traveling path between the virtual object and the virtual natural element on the map, identify the virtual object at one end of the traveling path, and identify the virtual natural element at an other end of the traveling path, the traveling path being configured to guide the virtual object to move into the sensing region of the virtual natural element along the traveling path.

In some embodiments, the apparatus further includes a target virtual natural element selection module. The target virtual natural element selection module is configured to: obtain, when a plurality of virtual natural elements exist, a distance between the virtual object and each virtual natural element in the virtual scene; and select the virtual natural element at a smallest distance from the virtual object as a target virtual natural element. The first display module is further configured to dynamically display a relative positional relationship between the virtual object and the target virtual natural element on the map.

In some embodiments, the apparatus further includes a second display module. The second display module is configured to display a first negative impact value caused by the virtual natural element to the virtual object when the virtual object is within the negative impact region of the virtual natural element. The first negative impact value is configured for indicating a degree of obstruction caused by the virtual natural element to movement of the virtual object within the negative impact region.

In some embodiments, the apparatus further includes an overlapping module. The overlapping module is configured to: determine a corresponding overlapping region when a plurality of virtual natural elements exist and negative impact regions of at least two of the plurality of virtual natural elements overlap; and superimpose, for the at least two virtual natural elements that constitute the overlapping region, first negative impact values caused by the virtual natural elements when the virtual object is in the overlapping region, to obtain a target first negative impact value for the virtual object. The second display module is further configured to display the target first negative impact value caused by the at least two virtual natural elements to the virtual object.

In some embodiments, the apparatus further includes a third display module. The third display module is configured to: obtain a duration of the virtual object in the virtual scene; and dynamically display a second negative impact value of the virtual object, the second negative impact value being positively correlated with the duration. The second negative impact value is configured for indicating a degree of obstruction caused to movement of the virtual object within the virtual scene.

In some embodiments, the second negative impact value is a value of a negative impact caused by a global impact source of the virtual scene to the virtual object, and the global impact source has a hidden attribute and an upgrade attribute. The upgrade attribute enables the global impact source to have at least two stages including a first stage and a second stage. The first stage corresponds to a first correlation coefficient between the second negative impact value and the duration, the second stage corresponds to a second correlation coefficient between the second negative impact value and the duration, and a value of the second correlation coefficient is greater than a value of the first correlation coefficient. The third display module is further configured to: obtain an initial value of the negative impact caused by the global impact source to the virtual object, and multiply the initial value by the value of the first correlation coefficient, to obtain a second negative impact value; dynamically display the second negative impact value; multiply the initial value by the value of the second correlation coefficient when it is determined that the global impact source progresses from the first stage to the second stage, to obtain a target negative impact value; and adjust the displayed second negative impact value to the target negative impact value.

In some embodiments, the virtual natural element has an upgrade attribute. The apparatus further includes an upgrade module. The upgrade module is configured to display upgrade prompt information corresponding to the virtual natural element when an upgrade condition of the virtual natural element is satisfied. The upgrade prompt information is configured for prompting that the virtual natural element has been upgraded, and an upgraded object obtained through transformation of the upgraded virtual natural element satisfies at least one of the following conditions: a health point is greater than a health point of the target object; and damage caused to the virtual object by performing an interactive operation is higher than damage caused to the virtual object by performing the interactive operation by the target object.

In some embodiments, the apparatus further includes an enhancement module. The enhancement module is configured to display, when a new virtual natural element is generated in the virtual scene and an overlapping region exists between a negative impact region of the generated new virtual natural element and the negative impact region of the virtual natural element, the new virtual natural element, and enhance an effect of a virtual natural phenomenon within the overlapping region.

In some embodiments, the apparatus further includes a generation module. The generation module is configured to: generate at least one interactive first object in an idle state when the virtual object is within the sensing region of the virtual natural element; and control the virtual object to interact with the first object in the virtual scene in response to an interaction instruction for the virtual object, the interaction being configured for transforming the first object from the idle state to an interactive state.

In some embodiments, the generation module is further configured to: obtain a level of the virtual object when the virtual object is within the sensing region of the virtual natural element, and determine an object type corresponding to the level based on the level; and generate the at least one interactive first object in the idle state based on the object type.

In some embodiments, the second control module 4552 is further configured to: display a search picture in which the target object searches the virtual scene for the virtual object; and control the virtual object to interact with the target object in the virtual scene when the target object finds the virtual object and performs the interactive operation on the virtual object and the interaction instruction for the target object is received.

In some embodiments, the apparatus further includes a third control module. The third control module is configured to control the target object to be transformed into the virtual natural element when the target object does not find the virtual object within the sensing region within a target duration.

In some embodiments, the apparatus further includes a state transition module. The state transition module is configured to: control the virtual object to be transformed from the interactive state to a hidden state in response to a hiding instruction for the virtual object, the hidden state causing the target object to be unable to sense the virtual object; display a picture in which the target object searches the virtual scene for the virtual object; and control the target object to be transformed into the virtual natural element when the target object does not find the virtual object in the hidden state within the target duration.

In some embodiments, the apparatus further includes a fourth control module. The fourth control module is configured to: control the virtual object to leave the sensing region in response to a region leaving operation for the virtual object; and control the target object to be transformed into the virtual natural element when a duration for which the virtual object leaves the sensing region reaches a target duration.

In some embodiments, the apparatus further includes a killing module. The killing module is configured to display, in the virtual scene, a virtual resource used as a reward when the virtual object kills the target object. The virtual resource is configured to be applied to the virtual scene.

In some embodiments, the apparatus further includes an elimination module. The elimination module is configured to radiatively eliminate a negative impact within the negative impact region caused by the virtual natural element at a preset rate with a position of the target object as a center when the virtual object kills the target object.

In some embodiments, the apparatus further includes a selection module. The selection module is configured to: display level options respectively corresponding to at least two difficulty levels, different difficulty levels corresponding to different quantities of virtual natural elements, the at least two difficulty levels including a target difficulty level, the target difficulty level corresponding to a target quantity of virtual natural elements; and display the virtual object and the target quantity of virtual natural elements belonging to the virtual natural phenomenon in the virtual scene in response to a selection operation of a level option for the target difficulty level.

In some embodiments, when a plurality of virtual natural elements exist, the plurality of virtual natural elements belong to at least two virtual natural phenomena. The display module 4551 is further configured to display a plurality of virtual natural elements belonging to the at least two virtual natural phenomena in the virtual scene. The virtual natural elements of different virtual natural phenomena cause different negative impacts to environments in which the virtual natural elements are located.

In some embodiments, the apparatus further includes a movement module. The movement module is configured to control the virtual object to move toward the virtual natural element in response to a movement instruction for the virtual object, and display an interactive second object in the virtual scene; display a picture in which the second object searches the virtual scene for the virtual object when the virtual object does not enter the negative impact region; and control the virtual object to interact with the second object in the virtual scene in response to the interaction instruction for the virtual object when the second object finds the virtual object and performs the interactive operation on the virtual object.

In some embodiments, the apparatus further includes a marking module. The marking module is configured to mark the virtual object, and display the virtual object carrying a mark when the virtual object enters the negative impact region. The mark is configured for causing the second object to be unable to find the virtual object.

In some embodiments, the display module 4551 is further configured to display, when the virtual natural phenomenon is a virtual tornado, a virtual natural element belonging to the virtual tornado in the virtual scene. A light intensity within a negative impact region of the virtual natural element is lower than that within a non-negative impact region in the virtual scene, and is destructive to a virtual object within the negative impact region.

An embodiment of this application further provides an electronic device. The electronic device includes:
a memory, configured to store a computer-executable instruction; and
a processor, configured to implement the interaction method in a virtual scene provided in the embodiments of this application when executing the computer-executable instruction stored in the memory.

An embodiment of this application provides a computer program product or a computer program, the computer program product or the computer program including a computer-executable instruction, the computer-executable instruction being stored in a non-transitory computer-readable storage medium. A processor of an electronic device reads the computer-executable instruction from the computer-readable storage medium. The processor executes the computer-executable instruction, so that the electronic device performs the interaction method in a virtual scene provided in the embodiments of this application.

An embodiment of this application provides a non-transitory computer-readable storage medium, having a computer-executable instruction stored therein, the computer-executable instruction, when executed by a processor, causing the processor to perform the interaction method in a virtual scene provided in the embodiments of this application, for example, the interaction method in a virtual scene shown in FIG. 3.

In some embodiments, the computer-readable storage medium may be a memory such as a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic memory, a compact disc, or a compact disc read-only memory (CD-ROM), or may be various devices including one or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units suitable for use in a computing environment.

In an example, the computer-executable instruction may but may not necessarily correspond to a file in a file system, may be stored in a part of the file for storing other programs or data, for example, stored in one or more scripts in a hyper text markup language (HTML) document, stored in a single file specially used for the discussed program, or stored in a plurality of collaborative files (for example, files storing one or more modules, a subprogram, or a code part).

In an example, the computer-executable instruction may be deployed to be executed on one electronic device, or executed on a plurality of electronic devices located at one location, or executed on a plurality of electronic devices distributed at a plurality of locations and connected through a communication network. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

Based on the above, the embodiments of this application have the following beneficial effects:
(1) When the virtual object is close to the virtual natural element, the virtual natural element is transformed into the interactive object to implement the interactive process, which enriches interactive objects during free exploration, reduces an exploration time, i.e., reduces a time for performing a human-computer interaction operation to implement the interactive process, thereby improving the efficiency of the human-computer interaction and a utilization rate of hardware resources of the electronic device.
(2) Timing is started from a transformation moment of the target object, and within this target time, sensing of the target object is disabled. Even if the virtual object approaches the target object or the virtual natural element again, the transformation process from the target object to the virtual natural element is not immediately interrupted, and the virtual natural element just transformed is not to be transformed into the target object again. In this way, an abnormal situation in which transformations between the virtual natural element and the target object repeat may be avoided when an extreme case occurs in which the virtual object repeatedly jumps across an edge of the sensing region.

The foregoing descriptions are merely the embodiments of this application and are not intended to limit the protection scope of this application. Any modification, equivalent replacement, and improvement made within the spirit and scope of this application all fall within the protection scope of this application.

What is claimed is:

1. An interaction method of controlling a virtual object in a virtual scene performed by an electronic device, the method comprising:
displaying a virtual object and a virtual natural element representing a virtual natural phenomenon in a virtual scene, wherein the virtual natural element is stationary in the virtual scene;
transforming the virtual natural element into an interactive target object when the virtual object is within a negative impact region of the virtual natural element; and
controlling the virtual object to interact with the target object in the virtual scene when an interaction instruction for the target object is received.

2. The method according to claim 1, wherein the method further comprises:
dynamically displaying a relative positional relationship between the virtual object and the virtual natural element on a map of the virtual scene.

3. The method according to claim 1, wherein the method further comprises:
displaying a first negative impact value caused by the virtual natural element to the virtual object when the virtual object is within the negative impact region of the virtual natural element, the first negative impact value indicating a degree of obstruction caused by the virtual natural element to movement of the virtual object within the negative impact region.

4. The method according to claim 1, wherein the method further comprises:
determining a duration of the virtual object in the virtual scene; and
dynamically displaying a second negative impact value of the virtual object, the second negative impact value being positively correlated with the duration, the second negative impact value indicating a degree of obstruction caused to movement of the virtual object within the virtual scene.

5. The method according to claim 1, wherein the method further comprises:
displaying upgrade prompt information corresponding to the virtual natural element when an upgrade condition of the virtual natural element is satisfied,
the upgrade prompt information indicating the interactive target object corresponding to the virtual natural element satisfying at least one of the following conditions:
a health point is greater than a health point of the target object; and
damage caused to the virtual object by performing an interactive operation is higher than damage caused to the virtual object by performing the interactive operation by the target object.

6. The method according to claim 1, wherein the method further comprises:
when a new virtual natural element is generated in the virtual scene and an overlapping region exists between a negative impact region of the generated new virtual natural element and the negative impact region of the virtual natural element, displaying the new virtual natural element, and enhancing an effect of a virtual natural phenomenon within the overlapping region.

7. The method according to claim 1, wherein the method further comprises:
generating at least one interactive first object in an idle state when the virtual object is within the negative impact region of the virtual natural element; and
controlling the virtual object to interact with the first object in the virtual scene in response to an interaction instruction for the virtual object, the interaction being configured for transforming the first object from the idle state to an interactive state.

8. The method according to claim 7, wherein the generating at least one interactive first object in an idle state when the virtual object is within the negative impact region of the virtual natural element comprises:
obtaining a level of the virtual object when the virtual object is within the negative impact region of the virtual natural element, and determining an object type corresponding to the level based on the level; and
generating the at least one interactive first object in the idle state based on the object type.

9. The method according to claim 1, wherein the controlling the virtual object to interact with the target object in the virtual scene when an interaction instruction for the target object is received comprises:
displaying a search picture in which the target object searches the virtual scene for the virtual object; and
controlling the virtual object to interact with the target object in the virtual scene when the target object finds the virtual object and performs the interactive operation on the virtual object and the interaction instruction for the target object is received.

10. The method according to claim 8, wherein the method further comprises:
transforming the target object back into the virtual natural element when the target object does not find the virtual object within the negative impact region within a target duration.

11. The method according to claim 1, wherein the method further comprises:
transforming the virtual object from the interactive state to a hidden state in response to a hiding instruction for the virtual object, the hidden state causing the target object to be unable to sense the virtual object;
displaying a picture in which the target object searches the virtual scene for the virtual object; and
controlling the target object to be transformed into the virtual natural element when the target object does not find the virtual object in the hidden state within the target duration.

12. The method according to claim 1, wherein the method further comprises:
radiatively eliminating the negative impact within the negative impact region caused by the virtual natural element at a preset rate with a position of the target object as a center when the virtual object kills the target object.

13. The method according to claim 1, wherein the method further comprises:
controlling the virtual object to move toward the virtual natural element in response to a movement instruction for the virtual object, and displaying an interactive second object in the virtual scene;
displaying a picture in which the second object searches the virtual scene for the virtual object when the virtual object does not enter the negative impact region; and
controlling the virtual object to interact with the second object in the virtual scene in response to the interaction instruction for the virtual object when the second object finds the virtual object and performs the interactive operation on the virtual object.

14. An electronic device, comprising:
a memory, configured to store a computer-executable instruction; and
a processor, configured to, when executing the computer-executable instruction stored in the memory, implement an interaction method for controlling a virtual object in a virtual scene including:
displaying a virtual object and a virtual natural element representing a virtual natural phenomenon in a virtual scene, wherein the virtual natural element is stationary in the virtual scene;
transforming the virtual natural element into an interactive target object when the virtual object is within a negative impact region of the virtual natural element; and
controlling the virtual object to interact with the target object in the virtual scene when an interaction instruction for the target object is received.

15. The electronic device according to claim 14, wherein the method further comprises:
determining a duration of the virtual object in the virtual scene; and
dynamically displaying a second negative impact value of the virtual object, the second negative impact value being positively correlated with the duration, the second negative impact value indicating a degree of obstruction caused to movement of the virtual object within the virtual scene.

16. The electronic device according to claim 14, wherein the method further comprises:
displaying upgrade prompt information corresponding to the virtual natural element when an upgrade condition of the virtual natural element is satisfied,
the upgrade prompt information indicating the interactive target object corresponding to the virtual natural element satisfying at least one of the following conditions:
a health point is greater than a health point of the target object; and
damage caused to the virtual object by performing an interactive operation is higher than damage caused to the virtual object by performing the interactive operation by the target object.

17. The electronic device according to claim 14, wherein the method further comprises:
when a new virtual natural element is generated in the virtual scene and an overlapping region exists between a negative impact region of the generated new virtual natural element and the negative impact region of the virtual natural element, displaying the new virtual natural element, and enhancing an effect of a virtual natural phenomenon within the overlapping region.

18. The electronic device according to claim 14, wherein the method further comprises:
generating at least one interactive first object in an idle state when the virtual object is within the negative impact region of the virtual natural element; and
controlling the virtual object to interact with the first object in the virtual scene in response to an interaction instruction for the virtual object, the interaction being configured for transforming the first object from the idle state to an interactive state.

19. The electronic device according to claim 14, wherein the controlling the virtual object to interact with the target object in the virtual scene when an interaction instruction for the target object is received comprises:
displaying a search picture in which the target object searches the virtual scene for the virtual object; and
controlling the virtual object to interact with the target object in the virtual scene when the target object finds the virtual object and performs the interactive operation on the virtual object and the interaction instruction for the target object is received.

20. A non-transitory computer-readable storage medium, having a computer-executable instruction stored therein, the computer-executable instruction, when executed by a processor of an electronic device, causing the electronic device to implement an interaction method for controlling a virtual object in a virtual scene including:
displaying a virtual object and a virtual natural element representing a virtual natural phenomenon in a virtual scene, wherein the virtual natural element is stationary in the virtual scene;
transforming the virtual natural element into an interactive target object when the virtual object is within a negative impact region of the virtual natural element; and
controlling the virtual object to interact with the target object in the virtual scene when an interaction instruction for the target object is received.
